(19) United States
(12) Patent Application Publication
(10) Pub. No.: US 2005/0141589 A1
(43) Pub. Date: Jun. 30, 2005

(54) Temperature sensing oscillator circuit

(75) Inventors: Dae Han Kwon, Seoul (KR); Kyung Wook Park, Icheon-si (KR)

Correspondence Address: HELLER EHRMAN WHITE & MCAULIFFE LLP, 1717 RHODE ISLAND AVE, NW, WASHINGTON, DC, 20036-3001, US

(73) Assignee: Hynix Semiconductor Inc., Gyeonggi-do (KR)

(21) Appl. No.: 10/879,518

(22) Filed: Jun. 30, 2004

(30) Foreign Application Priority Data
Dec. 26, 2003 (KR) 10-2003-0097457

(51) Int. Cl. G01K 7/00

(52) U.S. Cl. 374/117

(57) ABSTRACT

A temperature sensing oscillator circuit generates a pulse signal whose cycle is changed by temperature change. The temperature sensing oscillator circuit comprises a temperature sensing pulse generating unit and a pulse width regulating unit. The temperature sensing pulse generating unit changes an operating power supplied to an oscillator depending on temperature change to generate a pulse signal having a cycle varied depending on the temperature change. The pulse width regulating unit regulates a pulse width of a pulse signal outputted from the temperature sensing pulse generating unit. As a result, since the operating power of the oscillator is varied by temperature change, the configuration of the circuit is more simplified, and a refresh signal is stably generated at low temperature without additional signals.

### BACKGROUND OF THE INVENTION

1. Field of the Invention

The present invention generally relates to a temperature sensing oscillator circuit for generating a pulse signal whose period is changed depending on temperature by sensing temperature, and more specifically, to a temperature sensing oscillator circuit for regulating a period of a pulse signal outputted from an oscillator by varying an operating power of the oscillator depending on temperature change.

2. Description of the Prior Art

It is important how long mobile products such as a cellular phone or a laptop computer can be successively operated with given batteries. As a result, memory devices mounted on these products are required to have small power consumption. A low power DRAM and a Pseudo SRAM have been widely used for those memory devices.

In order to reduce power consumption in the memory devices, a self-refresh cycle is properly regulated depending on temperature change to reduce the amount of current required at a self-refresh mode to the maximum extent.

FIG. 1 is a circuit diagram of a conventional temperature sensing oscillating circuit for automatically regulating a self-refresh cycle depending on temperature change in a self-refresh circuit.

The temperature sensing oscillator circuit of FIG. 1 comprises a voltage comparison unit 11, an inversion delay unit 12, a control unit 13 and a temperature sensing unit 14.

The voltage comparison unit 11 compares an output voltage from the temperature sensing unit 14 with a reference voltage, and outputs a signal having a high level or a low level corresponding to the result of the comparison. The inversion delay unit 12 inverts and delays an output signal from the voltage comparison unit 11 to secure a predetermined pulse width of a refresh signal TEMPOSC. The control unit 13 controls generation of the refresh signal TEMPOSC depending on an output signal from the inversion delay unit 12, an output signal TOSCRSTB having a predetermined cycle regardless of temperature change, and a temperature sensing operating signal TEMPON. The temperature sensing unit 14 outputs a voltage varied by the temperature change to the voltage comparison unit 11.

In the temperature sensing oscillator circuit of FIG. 1, current flowing in serially connected NMOS transistors D1 and D2 of the temperature sensing unit 14 is differentiated depending on temperature change. The voltage comparison unit 11 receives a voltage varied by the NMOS transistors D1 and D2, and compares the voltage with the reference voltage to generates the refresh signal TEMPOSC with a variable cycle depending on temperature change.

In the temperature sensing oscillator circuit of FIG. 1, the cycle of the refresh signal TEMPOSC increases in a exponential form if temperature becomes lower so that the refresh signal TEMPOSC is not oscillated at less than a predetermined temperature.

FIG. 2 is a simulation diagram illustrating generation of a refresh signal with change of temperature at −15° C., 15° C., 45° C., 70° C. and 85° C. while a voltage VDD is applied to a terminal to receive the pulse signal TOSCRSTB in FIG. 1.

In FIG. 2, since the refresh signal TEMPOSC is not oscillated at less than 15° C., the circuit is not normally operated.

In order to solve the above-described problem, the control unit 11 receives the pulse signal TOSCRSTB having a predetermined period which is not affected by temperature change, and the refresh signal TEMPOSC is generated in response to the pulse signal TOSCRSTB at low temperature where the temperature sensing oscillator circuit of FIG. 1 does not operate. In this way, the conventional temperature sensing oscillator circuit requires an additional circuit to generate a pulse signal having a predetermined period which is not affected by temperature change.

### SUMMARY OF THE INVENTION

It is an object of the present invention to simplify configuration of a temperature sensing oscillator circuit and to improve characteristics of a refresh signal depending on temperature change.

In an embodiment, a temperature sensing oscillator circuit comprises a temperature sensing pulse generating unit and a pulse width regulating unit. The temperature sensing pulse generating unit changes an operating power supplied to an oscillator depending on temperature change to generate a pulse signal having a period varied depending on the temperature change. The pulse width regulating unit regulates a pulse width of a pulse signal outputted from the temperature sensing pulse generating unit to correspond to that of a refresh signal.

### BRIEF DESCRIPTION OF THE DRAWINGS

Other aspects and advantages of the present invention will become apparent upon reading the following detailed description and upon reference to the drawings in which:

FIG. 1 is a circuit diagram of a conventional temperature sensing oscillating circuit for automatically regulating a self-refresh cycle depending on temperature change in a self-refresh circuit;

FIG. 2 is a simulation diagram illustrating generation of a refresh signal while temperature of the circuit of FIG. 1 is changed;

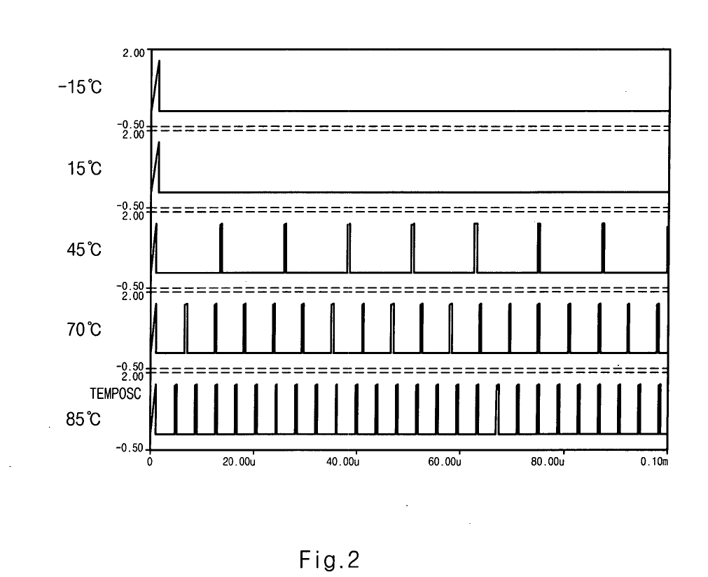

FIG. 3 is a circuit diagram of a temperature sensing oscillator circuit according to an embodiment of the present invention;

FIG. 4 is a diagram illustrating pulse waveforms of a pulse width regulating unit of FIG. 3;

FIG. 5 is a circuit diagram illustrating another example of a temperature sensing oscillator circuit according to an embodiment of the present invention;

FIG. 6 is a simulation diagram illustrating generation of a refresh signal while temperature of the circuit of FIG. 5 is changed.

### DETAILED DESCRIPTION OF THE PREFERRED EMBODIMENTS

The present invention will be described in detail with reference to the accompanying drawings.

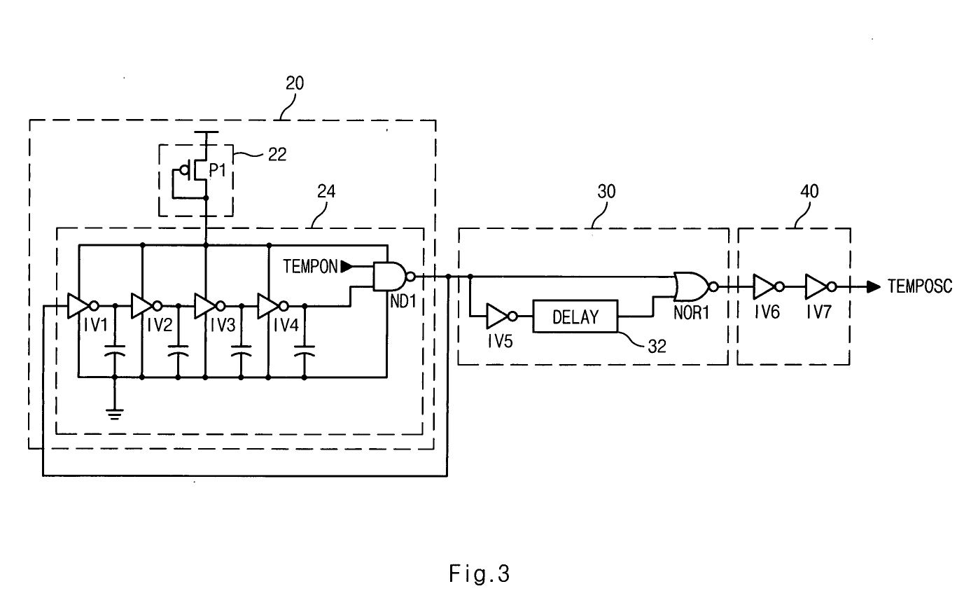

FIG. 3 is a circuit diagram of a temperature sensing oscillator circuit according to an embodiment of the present invention.

The temperature sensing oscillator circuit of FIG. 3 comprises a temperature sensing pulse generating unit 20, a pulse width regulating unit 30 and a buffer unit 40.

The temperature sensing pulse generating unit 20 outputs a pulse signal having a cycle varied by changing an operating power depending on temperature change. The temperature sensing pulse generating unit 20 comprises a variable power supply unit 22 and a ring oscillator 24.

The variable power supply unit 22 variably supplies a operating power of the ring oscillator 24 depending on temperature change. The variable power supply unit 22 comprises a diode-connected PMOS transistor P1 connected between a power voltage terminal VDD and the ring oscillator 24. In other words, in an embodiment, an internal power generated from the inside of the chip is not directly supplied to the ring oscillator 24 but through the diode-connected PMOS transistor P1. Here, the diode-connected PMOS transistor P1 supplies a variable operating power to the ring oscillator 24 depending on temperature change because a threshold voltage value of the diode-connected PMOS transistor P1 is differentiated by temperature change.

The ring oscillator 24 receives the operating power from the variable power supply unit 22, and outputs a pulse signal in response to a temperature sensing operating signal TEMPON. The ring oscillator 24 comprises an inverter chain including serially connected inverters IV1˜IV4 and a NAND gate ND1. The NAND gate ND1 performs a NAND operation on an output signal from the inverter chain and the temperature sensing operating signal TEMPON. An output signal from the NAND gate ND1 is applied to the pulse width regulating unit 30 and an inverter chain input terminal of the ring oscillator 24. That is, the ring oscillator 24 outputs an oscillated output signal from the inverter chain to the pulse width regulating unit 30 when the temperature sensing operating signal TEMPON is activated to a high level. The temperature sensing operating signal TEMPON to selectively operating the temperature sensing function is constantly kept on in an embodiment of the present invention.

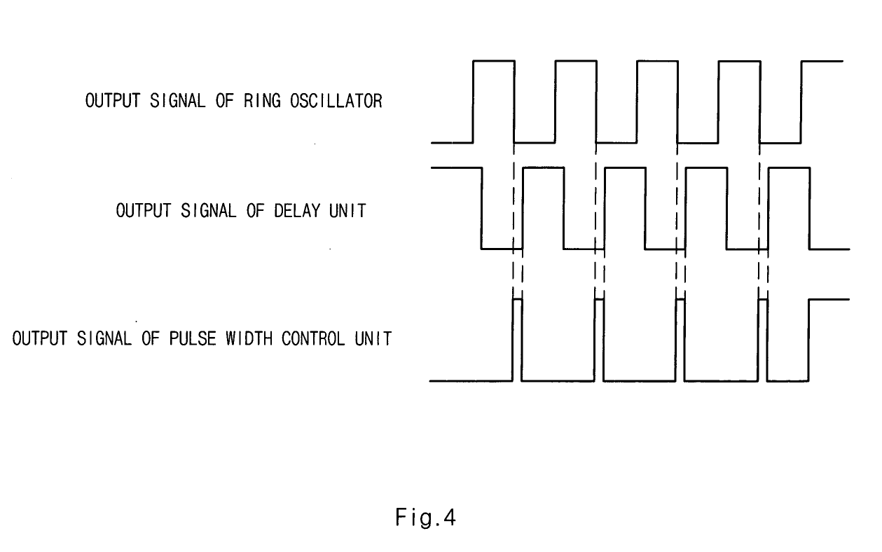

The pulse width regulating unit 30 regulates a pulse width of an output signal from the ring oscillator 24 to correspond to that of a refresh signal TEMPOSC. The pulse width regulating unit 30 comprises an inverter IV5, a delay unit 32 and a NOR gate NOR1. The inverter IV5 inverts an output signal from the ring oscillator 24. The delay unit 32 delays an output signal from the inverter IV5. The NOR gate NOR1 performs a NOR operation on output signals from the delay unit 32 and the ring oscillator 24. FIG. 4 is a diagram illustrating pulse waveforms of the pulse width regulating unit 30.

The buffer unit 40 buffers an output signal from the pulse width regulating unit 30, and outputs the refresh signal TEMPOSC. The buffer unit 40 comprises inverters IV6 and IV7 connected serially. The above-described buffer unit 40 is included in consideration of loading to other circuit which uses an output signal from the pulse width regulating unit 30 not for generation of the refresh signal TEMPOSC but for another object.

Hereinafter, the operation of the above-described temperature sensing oscillator circuit is described.

If the temperature sensing operating signal TEMPON is turned on, the inverters IV1˜IV4 and the NAND gate ND1 of the ring oscillator 24 receive the operating power from the variable power supply unit 22 to generate a pulse signal for the refresh signal TEMPOSC.

However, in common MOS transistors, a threshold voltage becomes higher if temperature becomes lower or lower if temperature becomes higher. As a result, the variable power supply unit 22 comprising the diode-connected PMOS transistor P1 supplies a lower operating power to the ring oscillator 24 as the temperature becomes lower, and a higher operating power to the ring oscillator 24 if the temperature becomes higher.

As the operating power supplied from the variable power supply unit 22 becomes lower, the response speed of the inverters IV1˜IV4 and the NAND gate ND1 in the ring oscillator 24 becomes slower gradually. As a result, the cycle of the pulse signal outputted from the ring oscillator 24 becomes longer as the temperature becomes lower.

On the other hand, as the operating power supplied from the variable power supply unit 22 becomes higher, the response speed of the inverters IV1˜IV4 and the NAND gate ND1 in the ring oscillator 24 becomes faster gradually. As a result, the cycle of the pulse signal outputted from the ring oscillator 24 becomes shorter.

In the above-describe way, the temperature sensing pulse generating unit 20 generates a pulse signal having a variable cycle by regulating the operating power of the ring oscillator 24 depending on temperature change. Accordingly, a pulse signal stably oscillated at low temperature can be generated without a pulse signal TOSCRSTB.

The pulse signal outputted from the ring oscillator 24 is regulated to have a pulse width proper to the refresh signal TEMPOSC.

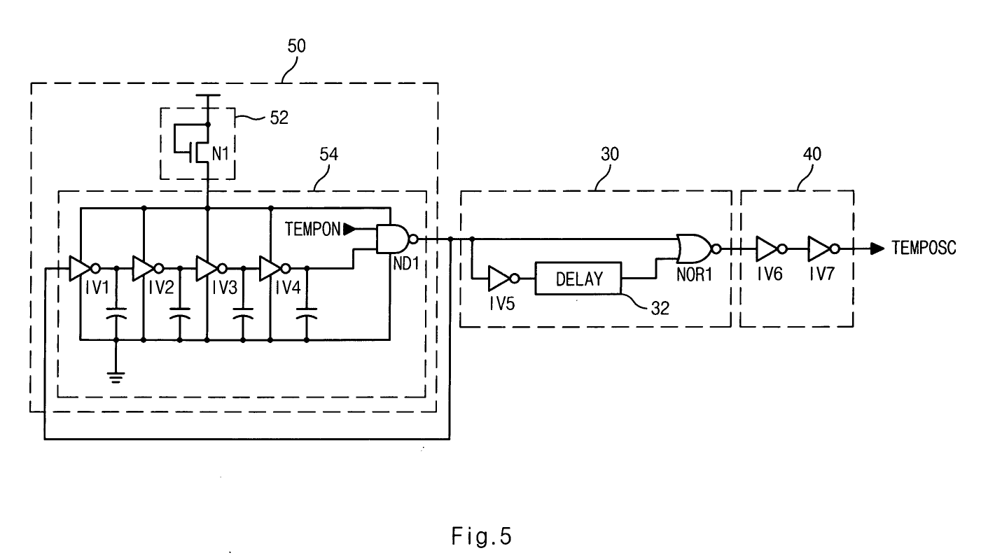

FIG. 5 is a circuit diagram illustrating another example of a temperature sensing oscillator circuit according to an embodiment of the present invention.

In the temperature sensing oscillator circuit of FIG. 5, the variable power supply unit 22 comprises a diode-connected NMOS transistor N1 instead of the diode-connected PMOS transistor P1. Since the other configuration of FIG. 5 is the same as that of FIG. 3, the same reference numbers are used and the detailed explanation is omitted.

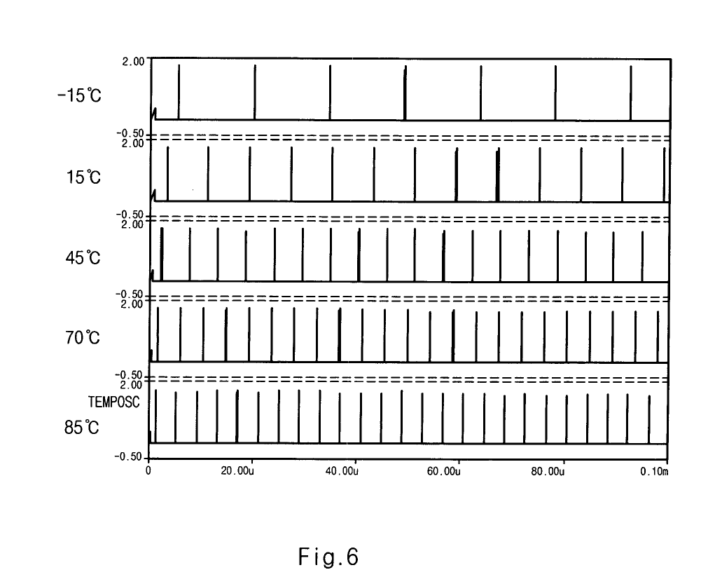

FIG. 6 is a simulation diagram illustrating generation of the refresh signal TEMPOSC with change of temperature at −15° C., 15° C., 45° C., 70° C. and 85° C. in temperature sensing oscillator circuit of FIG. 3 and FIG. 5.

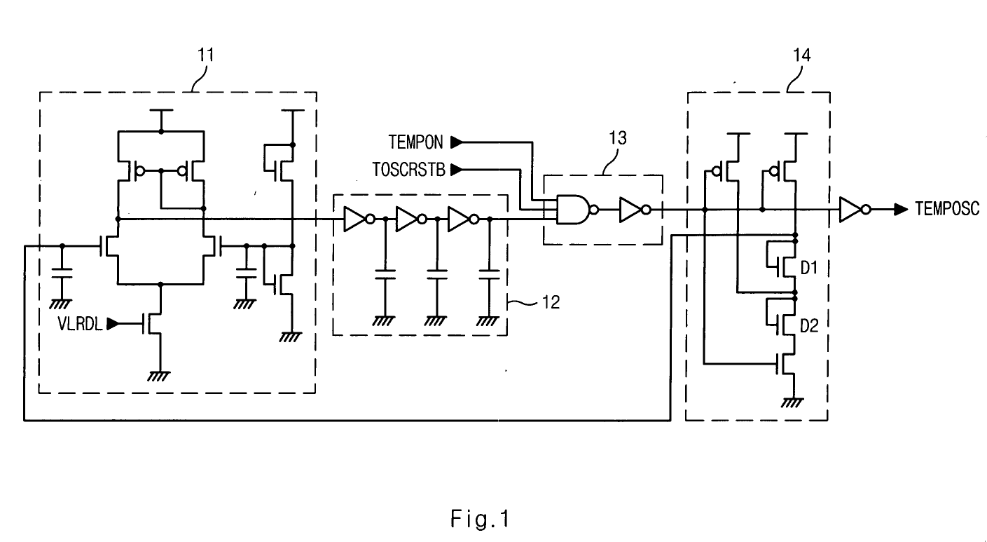

As shown in FIG. 6, the refresh signal TEMPOSC is stably oscillated at less than 15° C in the temperature sensing oscillator according to an embodiment of the present invention unlike the conventional temperature sensing oscillator circuit of FIG. 1.

As discussed earlier, in a temperature sensing oscillator circuit according to an embodiment of the present invention, the configuration of the circuit is simplified by changing an operating power of a ring oscillator which is a pulse generating unit depending on temperature change, and a refresh signal is stably generated at low temperature without additional signals.

While the invention is susceptible to various modifications and alternative forms, specific embodiments have been shown by way of example in the drawings and described in detail herein. However, it should be understood that the invention is not limited to the particular forms disclosed. Rather, the invention covers all modifications, equivalents, and alternatives falling within the spirit and scope of the invention as defined in the appended claims.

1. A temperature sensing oscillator circuit comprising:
a temperature sensing pulse generating unit for changing an operating power supplied to an oscillator depending on temperature to generate a pulse signal having a period varied depending on the temperature change; and
a pulse width regulating unit for regulating a pulse width of a pulse signal outputted from the temperature sensing pulse generating unit according to a refresh cycle.

2. The oscillator circuit according to claim 1, wherein the temperature sensing pulse generating unit comprises:
an oscillator for outputting a pulse signal in response to a temperature sensing operating signal; and
a variable power supply unit for variably supplying a operating power to the ring oscillator depending on the temperature change.

3. The oscillator circuit according to claim 2, wherein the variable power supply unit is a diode, connected between a power voltage terminal and the oscillator, whose threshold voltage value is changed depending on the temperature change.

4. The oscillator circuit according to claim 1, further comprising a buffer unit for buffering an output signal from the pulse width regulating unit.

5. The oscillator circuit according to claim 4, wherein the temperature sensing pulse generating unit comprises:
a oscillator for outputting a pulse signal in response to a temperature sensing operating signal; and
a variable power supply unit for variably supplying a operating power of the ring oscillator depending on the temperature change.

6. The oscillator circuit according to claim 5, wherein the variable power supply unit is a diode, connected between a power voltage terminal and the oscillator, whose threshold voltage value is changed depending on the temperature change.
